(19) United States
(12) Patent Application Publication
(10) Pub. No.: US 2026/0273664 A1
(43) Pub. Date: Sep. 17, 2026

(54) METHOD OF MANUFACTURING WELDED STRUCTURE, AND WELDED STRUCTURE

(71) Applicant: HONDA MOTOR CO., LTD., Tokyo (JP)

(72) Inventor: Kenichi FUKAMI, Saitama (JP)

(21) Appl. No.: 19/560,158

(22) Filed: Mar. 9, 2026

(30) Foreign Application Priority Data
Mar. 11, 2025 (JP) 2025-038329

(51) Int. Cl. B23K 26/323; B23K 26/244; B23K 26/60; B23K 101/00; B23K 103/04; B23K 103/10

(52) U.S. Cl. CPC B23K 26/323; B23K 26/244; B23K 26/60; B23K 2101/006; B23K 2103/04; B23K 2103/10

(57) ABSTRACT

To provide a welded structure in which a plurality of members are firmly joined with high weldability while suppressing a width required for welding. A method of manufacturing a welded structure performs first laser welding from an intermediate region of an entire length of laser welding for forming a single laser welded portion toward one end portion of the entire length, and performs second laser welding from the intermediate region toward the other end portion of the entire length while including a first welding start portion.

This application is based on and claims the benefit of priority from Japanese Patent Application No. 2025-038329, filed on 11 March 2025, the content of which is incorporated herein by reference.

### BACKGROUND OF THE INVENTION

### Field of the Invention

The present invention relates to a method of manufacturing a welded structure and to a welded structure.

### Related Art

In recent years, initiatives have been actively promoted to provide access to sustainable transportation systems that take into consideration vulnerable people among traffic participants, such as elderly persons, persons with disabilities, and children. In order to achieve this objective, research and development have focused on further improving traffic safety and convenience through development related to collision safety performance.

Conventionally, a technique for manufacturing a welded structure in which different members are connected by laser welding has been known. As an example of a document disclosing this type of technique, Patent Document 1 is cited.

Patent Document 1 relates to a structure in which flanges of two or more members are laser-welded. Patent Document 1 discloses that, in order to suppress fracture starting from a welding start point and a welding end point, additional weld beads are welded so as to intersect a weld bead at a welding start point and a welding end point of the weld bead.

Patent Document 1: Japanese Patent No. 3763525

### SUMMARY OF THE INVENTION

The technique disclosed in Patent Document 1 is useful in that an effect of reinforcing the welding start point and the welding end point of the weld bead can be achieved. However, a width for intersecting the additional weld bead with the flange of the member is required. There has been room for improvement in terms of suppressing a space required for welding while ensuring strength of the welded structure.

An object of the present invention is to provide a welded structure in which a plurality of members are firmly joined with high weldability while suppressing a width required for welding.

(1) The present disclosure relates to a method of manufacturing a welded structure by laser-welding a plurality of members, the method including: defining, with respect to an entire length of a single laser welded portion to be formed by the laser welding, a portion at which the laser welding is started from an intermediate region of the entire length as a first welding start portion; performing first laser welding from the first welding start portion toward one end portion of the entire length; and performing second laser welding from the first welding start portion toward the other end portion of the entire length, while including the first welding start portion.

According to (1), both ends in the entire length of a single laser welded portion become welding end portions, thereby suppressing fracture from end portions. Since the second laser welding overlaps the first welding start portion, heat input by laser welding is applied twice to the first welding start portion, and weldability is improved due to a larger amount of heat input as compared with a welding start portion of laser welding to which heat input is applied only once. Since laser welding can be stably performed without intersecting laser welds as in conventional techniques, a range required for laser welding can be reduced.

(2) The method of manufacturing a welded structure as described in (1), in which, within the entire length, a second welding length over which the second laser welding is performed is longer than a first welding length over which the first laser welding is performed.

According to (2), a laser welding time from the first welding start portion to one end portion can be shortened, the second laser welding can be performed while heat input of a first time remains at the first welding start portion, the amount of heat input to the first welding start portion can be further increased, and weldability can be further improved.

(3) The method of manufacturing a welded structure as described in (1), in which the first laser welding includes: a first preceding laser step configured to heat surfaces of the plurality of members; and a first laser welding step configured to join the plurality of members after the first preceding laser step, a first preceding welding start portion, which is a start of the first preceding laser step, is located closer to the other end portion than a first welding start portion, which is a start of the first laser welding step, the second laser welding includes: a second preceding laser step configured to heat surfaces of the plurality of members; and a second laser welding step configured to join the plurality of members after the second preceding laser step, and the second preceding laser step is performed from a second preceding welding start portion, which is a start of the second preceding laser step, toward the other end portion while overlapping the second preceding welding start portion with the first preceding welding start portion.

According to (3), surfaces of the members are heated in the first preceding laser step and the second preceding laser step, and removal of a plating film of the members and adjustment of surface irregularities can be achieved. Since the first preceding welding start portion of the first preceding laser step is located closer to the other end portion than the first welding start portion of the first laser welding step, the first laser welding step can be executed after reliably performing the first preceding laser step at the first welding start portion. Since a region in which the first preceding laser step has been performed has already been heated, the second preceding laser step is performed toward the other end portion while overlapping the second preceding welding start portion with the first preceding welding start portion. As a result, a range of the second preceding laser step is shortened as compared with a case where the second preceding laser step is performed over an entire region of the second laser welding step.

(4) The method of manufacturing a welded structure as described in (1), in which the plurality of members include a steel plate composed of a steel material, and an aluminum member composed of an aluminum alloy.

According to (4), laser welding between a steel plate and an aluminum member, in which weldability at a welding start portion tends to become unstable, is dissimilar material joining that is difficult due to differences in melting point and thermal conductivity; however, this laser welding can be stably performed by the present technique in which both ends of a laser welded portion do not become welding start portions.

(5) The method of manufacturing a welded structure as described in (4), in which the plurality of members include: a skeletal member composed of a steel plate and configured to form a closed cross section by joining an outer member and an inner member at a flange portion; and

an outer panel member composed of an aluminum member and welded to the flange portion by the laser welding.

According to (5), it is no longer necessary to provide, on the flange portions, a width for intersecting laser welds as in conventional techniques, and a degree of freedom in layout and design of the flange portions is improved.

(6) The present disclosure also relates to a welded structure in which a plurality of members are joined by a laser welded portion formed by laser welding, the welded structure including: a single laser welded portion having an entire length; a first laser welded portion extending from a first welding start portion toward one end portion of the entire length, the first welding start portion being a portion at which the laser welding is started from an intermediate region of the entire length; and a second laser welded portion extending from the first welding start portion toward the other end portion of the entire length, while including the first welding start portion.

According to (6), both ends in the entire length of a single laser welded portion become welding end portions, thereby suppressing fracture from end portions. Since the second laser welded portion overlaps the first welding start portion, heat input by laser welding is applied twice to the first welding start portion, and weldability is improved due to a larger amount of heat input as compared with a welding start portion of laser welding to which heat input is applied only once. Since laser welding can be stably performed without intersecting laser welds as in conventional techniques, a range required for laser welding can be reduced.

(7) The welded structure as described in (6), in which, in the entire length, a second welding length, which is a length of the second laser welded portion, is longer than a first welding length, which is a length of the first laser welded portion.

According to (7), a laser welding time from the first welding start portion to one end portion (a first welding end portion) can be shortened, the second laser welding can be performed while heat input of a first time remains at the first welding start portion, the amount of heat input to the first welding start portion can be further increased, and weldability can be further improved.

(8) The welded structure as described in (6), in which the plurality of members include a steel plate composed of a steel material, and an aluminum member composed of an aluminum alloy.

According to (8), laser welding between a steel plate and an aluminum member, in which weldability at a welding start portion tends to become unstable, is dissimilar material joining that is difficult due to differences in melting point and thermal conductivity; however, this laser welding can be stably performed by the present technique in which both ends of a laser welded portion do not become welding start portions.

(9) The welded structure as described in (8), in which the plurality of members include: a skeletal member composed of a steel plate and configured to form a closed cross section by joining an outer member and an inner member at a flange portion; and an outer panel member composed of an aluminum member and welded to the flange portion by the laser welding.

According to (9), it is no longer necessary to provide, on the flange portion, a width for intersecting laser welds as in conventional techniques, and a degree of freedom in layout and design of the flange portions is improved.

According to the present invention, it is possible to provide a welded structure in which a plurality of members are firmly joined with high weldability while suppressing a width required for welding.

### BRIEF DESCRIPTION OF THE DRAWINGS

FIG. 1 is a diagram illustrating a vehicle body component, to which a welded structure according to one embodiment of the present invention is applied;

FIG. 2 is an enlarged diagram illustrating a portion of the welded structure of the present embodiment in the vehicle body component;

FIG. 3 is a cross-sectional view taken along the line A–A of FIG. 2;

FIG. 4 is a schematic diagram illustrating a first step in a method of manufacturing a welded structure according to a first embodiment;

FIG. 5 is a schematic diagram illustrating a second step in the method of manufacturing the welded structure according to the first embodiment;

FIG. 6 is a cross-sectional view taken along the line B–B of FIG. 5;

FIG. 7 is a schematic diagram illustrating a first step in a method of manufacturing a welded structure according to a second embodiment;

FIG. 8 is a schematic diagram illustrating a second step in the method of manufacturing the welded structure according to the second embodiment;

FIG. 9 is a schematic diagram illustrating a first stage of a heating step among manufacturing steps of a welded structure according to a third embodiment;

FIG. 10 is a schematic diagram illustrating a second stage of the heating step among the manufacturing steps of the welded structure according to the third embodiment;

FIG. 11 is a schematic diagram illustrating a cooling step among the manufacturing steps of the welded structure according to the third embodiment;

FIG. 12 is a schematic diagram illustrating a laser welding step among the manufacturing steps of the welded structure according to the third embodiment; and

FIG. 13 is a schematic diagram illustrating a laser welded portion formed in the manufacturing steps of the welded structure according to the third embodiment.

### DETAILED DESCRIPTION OF THE INVENTION

Hereinafter, one embodiment of the present invention will be described with reference to the drawings.

### Welded Structure

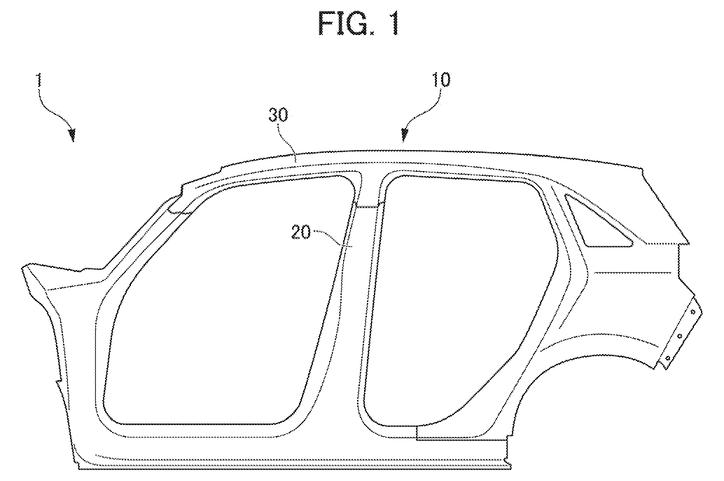

First, a configuration of a welded structure 10 of the present embodiment will be described. FIG. 1 is a diagram illustrating a vehicle body component 1, to which the welded structure 10 according to one embodiment of the present invention is applied. FIG. 1 illustrates, as an application example of the welded structure 10, a vehicle body component 1 that constitutes a door opening portion of a vehicle body. The welded structure 10 is not limited to the vehicle body component 1 and can be applied to other uses.

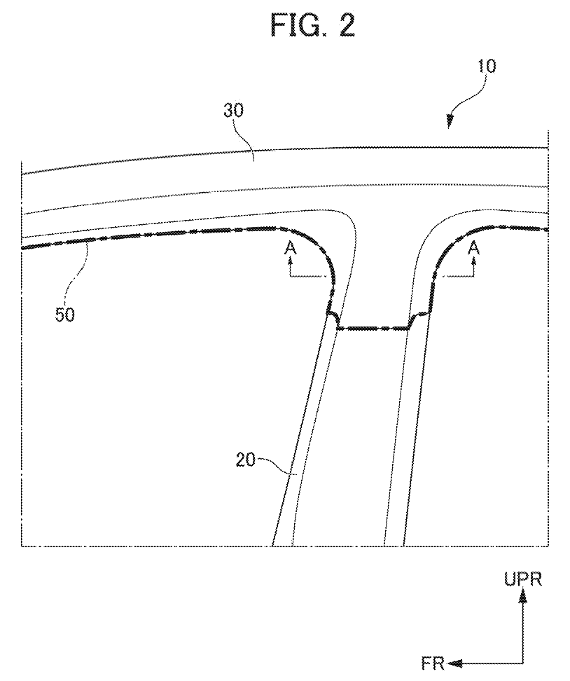

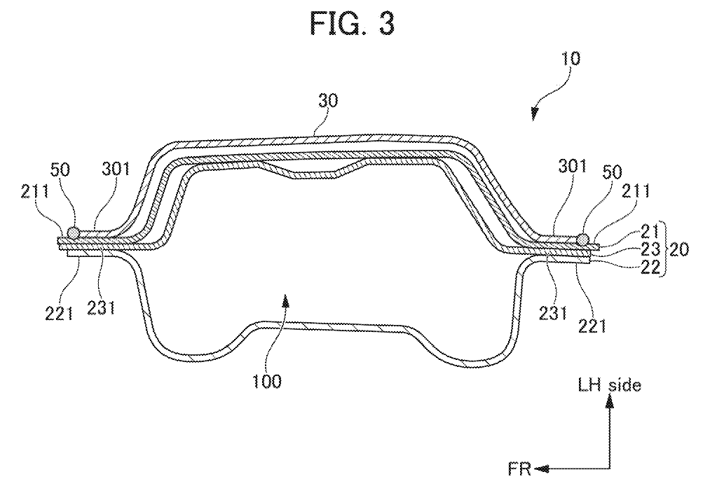

FIG. 2 is an enlarged diagram illustrating a portion including the welded structure 10 of the present embodiment in the vehicle body component 1. In FIG. 2, FR indicates a front side of the vehicle body, and UPR indicates an upper side of the vehicle body. In FIG. 2, a laser welded portion 50 formed by laser welding is illustrated by a chain line. FIG. 3 is a cross-sectional view taken along the line A–A of FIG. 2. In FIG. 3, FR indicates a front side of the vehicle body, and LH side indicates a left side of the vehicle body.

As illustrated in FIGS. 2 and 3, the welded structure 10 of the present embodiment includes a skeletal member 20 and an outer panel member 30.

The skeletal member 20 is a vehicle body member including an outer member 21, an inner member 22, and a reinforcing stiffener 23. The outer member 21, the inner member 22, and the reinforcing stiffener 23 are each composed of, for example, a steel plate formed of a steel material.

As illustrated in FIG. 3, the outer member 21 is a first member configured to protrude outward in a vehicle left-right direction. Outer-side flange portions 211 are formed on both sides of a main body portion of the outer member 21.

The inner member 22 is a first member configured to protrude inward in the vehicle left-right direction. Inner-side flange portions 221 are formed on both sides of the inner member 22.

The outer member 21 and the inner member 22 are joined by joining the outer-side flange portions 211 on both sides and the inner-side flange portions 221 on both sides, respectively. In the present embodiment, the reinforcing stiffener 23 also includes stiffener-side flange portions 231 on both sides. Joining is performed in a state in which the stiffener-side flange portions 231 are sandwiched between the outer-side flange portions 211 and the inner-side flange portions 221.

A method of joining the outer member 21 and the inner member 22 is not particularly limited. For example, the stiffener-side flange portions 231 are joined in a state of being sandwiched by the outer-side flange portions 211 and the inner-side flange portions 221 by laser welding, spot welding, mechanical fastening, or the like. Accordingly, a closed cross section 100 is formed by the outer member 21 and the inner member 22. The reinforcing stiffener 23 may be omitted from the skeletal member 20.

Next, the outer panel member 30 will be described. The outer panel member 30 is composed of, for example, a metal such as aluminum, magnesium, or an alloy thereof. A laser welded portion 50 is formed on the outer panel member 30 by laser welding, and the outer panel member 30 is joined to the outer member 21 via the laser welded portion 50. FIG. 3 illustrates a cross-sectional portion of the laser welded portion 50. In the present embodiment, outer panel flange portions 301 are also formed on both sides of the outer panel member 30, and the outer panel flange portions 301 are joined to the outer-side flange portions 211 of the outer member 21 via the laser welded portion 50.

### Method of Manufacturing Welded Structure According to First Embodiment

Next, a manufacturing process of the welded structure 10 will be described. The method of manufacturing the welded structure 10 according to the first embodiment includes a first step of performing first laser welding, and a second step of performing second laser welding.

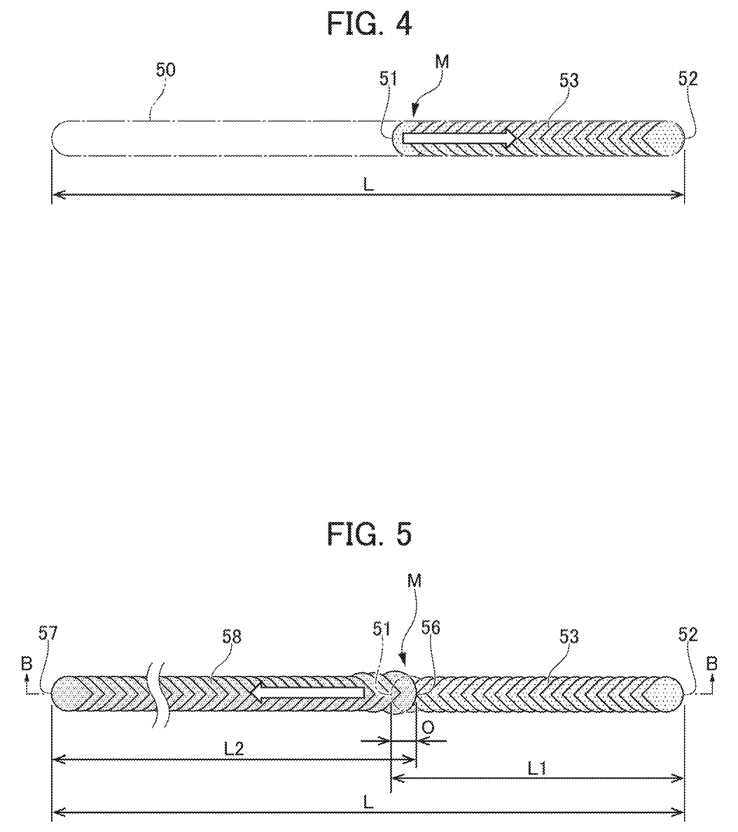

FIG. 4 is a schematic diagram illustrating the first step in the method of manufacturing the welded structure 10 according to the first embodiment. FIG. 4 schematically illustrates a state in which lap welding is performed by irradiating a laser from a surface side of the outer panel member 30. The lap welding may be performed in a form in which an end portion of one of two members and a planar portion of the other member are joined by the laser welded portion 50, or may be performed in a form in which a laser penetrates a planar portion of one member and planar portions of one member and the other member are joined by the laser welded portion 50. In FIG. 4, a range of the laser welded portion 50 to be subjected to laser welding is illustrated by a chain line. Hereinafter, a right side on the drawing sheet is referred to as one end portion side, and a left side on the drawing sheet is referred to as the other end portion side.

As illustrated in FIG. 4, in the first step, laser welding is performed not over the entire region of the laser welded portion 50 but on a part of the laser welded portion 50. In the first step, an intermediate region M of an entire length L of the laser welded portion 50 to be subjected to laser welding serves as a first welding start portion 51, which is a starting point at which the first laser welding is started. Laser welding is performed from the first welding start portion 51 toward a first welding end portion 52 on the one end portion side of the laser welded portion 50. Accordingly, a first laser welded portion 53 that joins the outer panel member 30 and the outer member 21 is formed.

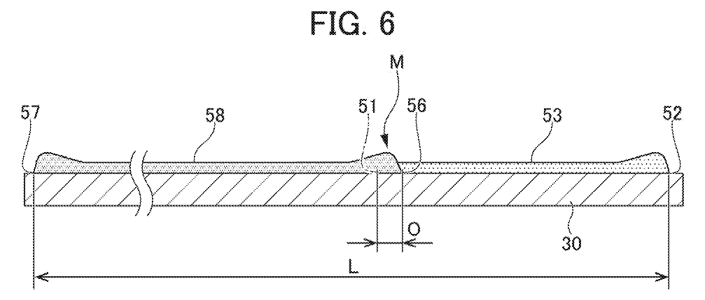

FIG. 5 is a schematic diagram illustrating the second step in the method of manufacturing the welded structure 10 according to the first embodiment. FIG. 5 schematically illustrates a state in which lap welding is performed by irradiating a laser from the surface of the outer panel member 30. FIG. 6 is a cross-sectional view taken along the line B–B of FIG. 5.

As illustrated in FIGS. 5 and 6, in the second step, laser welding is performed on the remaining portion of the laser welded portion 50. In the second step, laser welding is performed from a second welding start portion 56, which is located in the intermediate region M of the laser welded portion 50 and overlaps the first welding start portion 51, toward a second welding end portion 57 located on an opposite side of the first welding end portion 52. The second welding end portion 57 is also the other end portion of the laser welded portion 50. Accordingly, a second laser welded portion 58 that joins the outer panel member 30 and the outer member 21 is formed.

Positions of the first welding start portion 51, the first welding end portion 52, the second welding start portion 56, and the second welding end portion 57 in the first step are set such that a second welding length L2 of the second laser welded portion 58 is longer than a first welding length L1 of the first laser welded portion 53. The first laser welded portion 53 and the second laser welded portion 58 include a partially overlapping region O, in which a relationship of L < L1 + L2 is satisfied, where L denotes the entire length.

Through the series of processes described above, laser welding is performed over an entire region of the laser welded portion 50. FIGS. 4 and 5 illustrate a linear laser welded portion 50, but this is not limiting. The laser welded portion 50 may be bent along the path or may have a curved shape such as an arc.

As described above, in the method of manufacturing the welded structure 10 according to the first embodiment, with respect to the entire length L of laser welding for forming a single laser welded portion 50, the first laser welding is performed toward one end portion of the entire length L by setting, as a first welding start portion 51, a portion at which the laser welding is started from an intermediate region M of the entire length L, and the second laser welding is performed toward the other end portion of the entire length L while including the first welding start portion 51. Further, the welded structure 10 of the present embodiment includes, with respect to the entire length L of a single laser welded portion 50, the first laser welded portion 53 extending toward one end portion of the entire length L from the first welding start portion 51, which is a portion at which the laser welding is started from the intermediate region M of the entire length L, and the second laser welded portion 58 extending toward the other end portion of the entire length L while including the first welding start portion 51.

With the method of manufacturing the welded structure 10 and the welded structure 10 configured as described above, both ends in the entire length L of a single laser welded portion become welding end portions, thereby suppressing fracture from end portions. Since the second laser welding overlaps the first welding start portion 51, heat input by laser welding is applied twice to the first welding start portion 51, and weldability is improved due to a larger amount of heat input as compared with a welding start portion of laser welding to which heat input is applied only once. Since laser welding can be stably performed without intersecting laser welds as in conventional techniques, a range required for laser welding can be reduced.

In the method of manufacturing the welded structure 10 of the present embodiment, the second welding length L2, which is a length over which the second laser welding is performed, is longer than the first welding length L1, which is a length over which the first laser welding is performed, in the entire length L. In the welded structure 10 of the present embodiment, the second welding length L2, which is a length of the second laser welded portion 58, is longer than the first welding length L1, which is a length of the first laser welded portion 53, in the entire length L.

Accordingly, a laser welding time from the first welding start portion 51 to the first welding end portion 52, which is one end portion, can be shortened, the second laser welding can be performed while heat input of a first time remains at the first welding start portion 51, the amount of heat input to the first welding start portion 51 can be further increased, and weldability can be further improved.

### Method of Manufacturing Welded Structure According to Second Embodiment

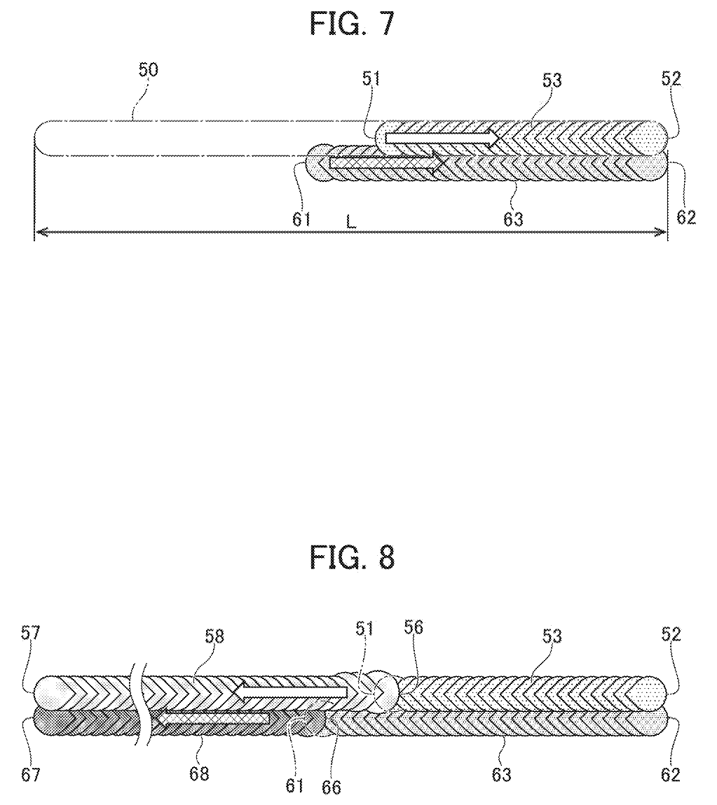

Next, with reference to FIGS. 7 and 8, a method of manufacturing the welded structure 10 according to a second embodiment, which differs from the first embodiment, will be described. In the following description, components that are the same as or similar to those described in the above embodiment may be denoted by the same reference numerals, and detailed descriptions thereof may be omitted.

FIG. 7 is a schematic diagram illustrating a first step in the method of manufacturing the welded structure 10 according to the second embodiment. As illustrated in FIG. 7, the first step of the second embodiment is performed in stages including a preceding laser step configured to heat a surface of one or both of the outer panel member 30 and the outer member 21, which are laser irradiation surfaces, and a laser welding step configured to join the outer panel member 30 and the outer member 21 after the preceding laser step.

In the preceding laser step in the first step, a first preceding welding start portion 61 is set at a position farther from the first welding end portion 52 in the welding direction than a position at which the first welding start portion 51 is set in the first step. In the preceding laser step, heating by laser irradiation is performed from the first preceding welding start portion 61 to the first preceding welding end portion 62 located at a position corresponding to the first welding end portion 52 on the one end portion side. In FIG. 7, a heated region 63 heated in the preceding laser step is illustrated as being shifted downward on the drawing sheet for convenience of explanation. The heated region 63 corresponds to a portion where the first laser welded portion 53 is formed.

In the laser welding step in the first step, the first welding start portion 51 is set closer to the first welding end portion 52 than the first preceding welding start portion 61. In the first step, laser welding by laser irradiation is performed on the outer panel member 30 from the first welding start portion 51 toward the first welding end portion 52 in a state in which a surface of the outer panel member 30 has been heated. Accordingly, the first laser welded portion 53 that joins the outer panel member 30 and the outer member 21 is formed.

FIG. 8 is a schematic diagram illustrating a second step in the method of manufacturing the welded structure 10 according to the second embodiment. As illustrated in FIG. 8, the second step of the second embodiment is also performed in stages including a preceding laser step configured to heat a surface of the outer panel member 30, which is a laser irradiation surface, and a laser welding step configured to join the outer panel member 30 and the outer member 21 after the preceding laser step.

In the preceding laser step in the second step, the second preceding welding start portion 66 is set at a position corresponding to the first preceding welding start portion 61. In the preceding laser step, heating by laser irradiation is performed from the second preceding welding start portion 66 to a second preceding welding end portion 67 located at a position corresponding to the second welding end portion 57 on the other end portion side. In FIG. 8, a heated region 68 heated in the preceding laser step is illustrated as being shifted downward on the drawing sheet for convenience of explanation. The heated region 68 corresponds to a portion where the second laser welded portion 58 is formed.

In the laser welding step in the second step, the second welding start portion 56 is set closer to the first welding end portion 52 than the first preceding welding start portion 61 and the second preceding welding start portion 66. In the laser welding step, laser welding is performed, on the outer panel member 30 from the second welding start portion 56, which overlaps the first welding start portion 51, toward the second welding end portion 57 on the other end portion side, in a state in which a surface of the outer panel member 30 has been heated. Accordingly, the second laser welded portion 58 that joins the outer panel member 30 and the outer member 21 is formed.

As described above, in the method of manufacturing the welded structure 10 according to the second embodiment, the first laser welding includes: the first preceding laser step configured to heat a surface of one or both of the outer panel member 30 and the outer member 21, which are members among the plurality of members; and the first laser welding step configured to join the outer panel member 30 and the outer member 21, which are the plurality of members, after the first preceding laser step. The first preceding welding start portion 61, which is a start of the first preceding laser step, is located closer to the other end portion than the first welding start portion 51, which is a start of the first laser welding step. The second laser welding includes: the second preceding laser step configured to heat a surface of the outer panel member 30; and the second laser welding step configured to join the outer panel member 30 and the outer member 21, which are the plurality of members, after the second preceding laser step. The second preceding laser step is performed toward the other end portion while overlapping a second preceding welding start portion 66, which is a start of the second preceding laser step, with the first preceding welding start portion 61.

In the welded structure 10 according to the second embodiment, the first laser welded portion 53 is welded in the first preceding laser step and the first laser welding step. The first preceding welding start portion 61, which is a start of the first preceding laser step, is located closer to the other end portion than the first welding start portion 51, which is a start of the first laser welding step. The second laser welded portion 58 is welded in the second preceding laser step and the second laser welding step. The second preceding laser step is performed toward the other end portion while overlapping the second preceding welding start portion 66, which is a start of the second preceding laser step, with the first preceding welding start portion 61.

With the method of manufacturing the welded structure 10 and the welded structure 10 configured as described above, surfaces of components such as the outer panel member 30 and the outer member 21 are heated in the first preceding laser step and the second preceding laser step, thereby enabling removal of a plating film of the components and adjustment of surface irregularities. Since the first preceding welding start portion 61 in the first preceding laser step is located closer to the other end portion than the first welding start portion 51 of the first laser welding step, the first laser welding step can be executed after reliably performing the first preceding laser step at the first welding start portion 51. Since a region in which the first preceding laser step has been performed has already been heated, the second preceding laser step is performed toward the other end portion while overlapping the second preceding welding start portion 66 with the first preceding welding start portion 61. As a result, a range of the second preceding laser step is shortened as compared with a case where the second preceding laser step is performed over the entire region of the second laser welding step.

### Method of Manufacturing Welded Structure According to Third Embodiment

Next, a third embodiment will be described in which the outer panel member 30 is composed of an aluminum alloy, and the outer member 21, to which the outer panel member 30 is joined by laser welding, is composed of a steel material. Since an aluminum alloy and a steel material differ in melting point and thermal conductivity, joining of these materials is dissimilar material joining that is generally difficult to weld. In the third embodiment, in order to favorably perform dissimilar material joining, the outer member 21 is used in which a surface layer 322 having a melting point higher than that of the outer panel member 30 composed of an aluminum alloy is formed on a surface of the outer member 21 composed of a steel material. In the third embodiment, the first laser welding and the second laser welding are performed by the same laser welding method, and, in the following description, the laser welded portion 50 indicates either the first laser welded portion 53 or the second laser welded portion 58.

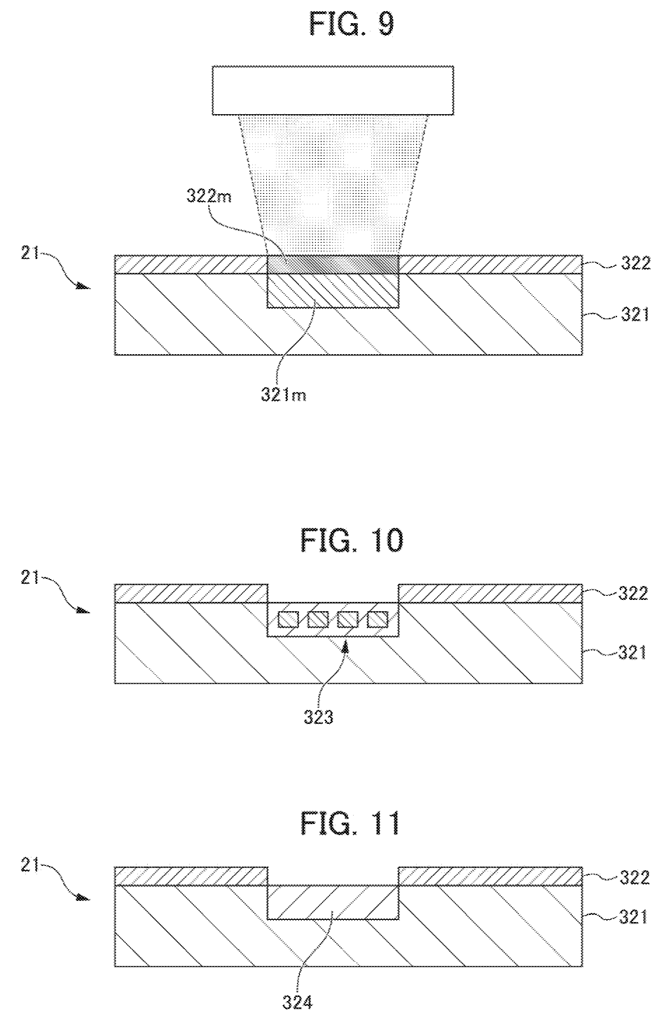

FIG. 9 is a schematic diagram illustrating a first stage of a heating step among manufacturing steps of the welded structure 10 according to the third embodiment. FIG. 10 is a schematic diagram illustrating a second stage of the heating step among the manufacturing steps of the welded structure 10 according to the third embodiment.

First, a configuration of the outer member 21 according to the third embodiment will be described. The outer member 21 according to the third embodiment is configured by forming a surface layer 322 on a surface of a base steel material 321. The surface layer 322 is, for example, an Fe–Al layer, an oxide film layer, or a galvannealed zinc plating (GA) layer. For example, when the surface layer 322 is an Fe–Al layer, the surface layer 322 is a layer including an intermetallic compound. The intermetallic compound is not particularly limited as long as the intermetallic compound includes iron (Fe) and aluminum (Al), and examples thereof include an Al–Si–Fe-based intermetallic compound. The Fe–Al layer may include an alloy in addition to the intermetallic compound, and may include, for example, an Fe–Al alloy. A thickness of the Fe–Al layer in the steel material 321 outside the laser welded portion 50 is not particularly limited. The thickness of the Fe–Al layer may be, for example, 10 μm to 50 μm, or may be 20 μm to 40 μm.

As illustrated in FIG. 9, in the first stage of the heating step, a portion of the surface layer 322 of the outer member 21, at which the outer panel member 30 is to be joined, is heated by laser irradiation to a temperature equal to or higher than a melting point and equal to or lower than a boiling point of the surface layer 322, and the steel material 321 at a position adjacent to the heated surface layer 322 in a thickness direction is heated to a temperature equal to or higher than a melting point and equal to or lower than a boiling point of the steel material 321. In the heating step, a part of the surface layer 322 becomes a molten layer 322m in a molten state. Similarly, a part of the steel material 321 also becomes a molten layer 321m in a molten state.

As illustrated in FIG. 10, in the second stage of the heating step, a molten layer 323 in which the molten layer 321m and the molten layer 322m are mixed is generated. At this time, when the surface layer 322 is an Fe–Al layer, it is preferable that volumes of the molten layer 321m and the molten layer 322m be adjusted such that an aluminum content derived from the surface layer 322 is within 10 mass% of Fe contained in the molten layer 323. Accordingly, generation of intermetallic compounds can be suppressed, and strength can be improved. The adjustment described above can be performed, for example, by adjusting a laser temperature and an irradiation time in the heating step.

FIG. 11 is a schematic diagram illustrating a cooling step among the manufacturing steps of the welded structure 10 according to the third embodiment. Since the outer panel member 30 is a material different from the base steel material 321, it is preferable to perform, after the heating step, a cooling step of lowering a surface temperature of the steel material 321 to equal to or lower than a melting point of the steel material 321 (the molten layer 323). In the cooling step, as illustrated in FIG. 11, a solid-solution layer 324, in which the molten layer 323 is solidified, is formed at a joined portion of the outer member 21. In a laser joining step described below, by joining the outer panel member 30 to the solid-solution layer 324, generation of an intermetallic compound having an excessive thickness between the outer member 21 and the outer panel member 30 can be suppressed.

In the cooling step, in particular, when the material of the outer panel member 30 is aluminum having a lower melting point than that of the outer member 21, it is preferable to lower the surface temperature of the outer member 21 to around a melting point of the outer panel member 30 (for example, approximately 660°C). In this state, by joining the outer panel member 30 to the solid-solution layer 324 in a laser welding step described below, generation of an intermetallic compound layer 327 described below having an excessive thickness between the outer member 21 and the outer panel member 30 can be more preferably suppressed.

In the cooling step, joining is possible even when the surface temperature of the outer member 21 is lowered to equal to or lower than the melting point of the outer panel member 30, however, it is preferable to lower the surface temperature to around the melting point of the outer panel member 30. Accordingly, heat in the heating step can be utilized to a maximum extent to ensure initial wettability in joining of the outer panel member 30, thereby contributing to increased processing speed and stabilization of quality.

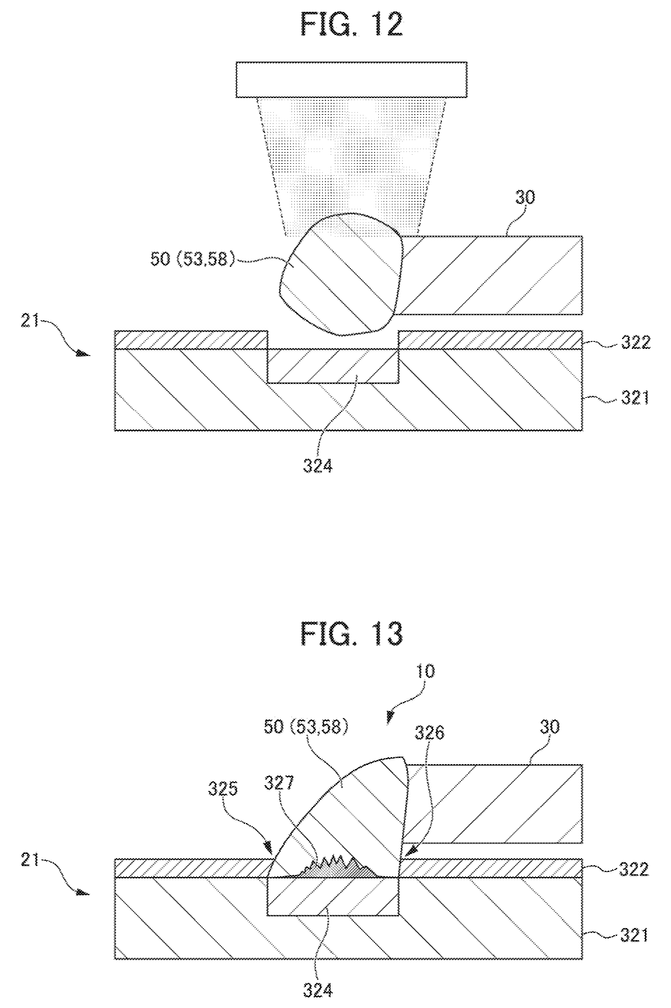

FIG. 12 is a schematic diagram illustrating a laser welding step among the manufacturing steps of the welded structure 10 according to the third embodiment. The laser welding step illustrated in FIG. 12 is a step of joining the outer panel member 30 to the solid-solution layer 324 after the cooling step, and corresponds to the first laser welding or the second laser welding of the above embodiment.

In the laser welding step according to the third embodiment, a joining portion of the outer panel member 30 is melted by heating and becomes a laser welded portion 50, which is the first laser welded portion 53 or the second laser welded portion 58, and is joined to the solid-solution layer 324. The heating temperature in the laser welding step may be, for example, a temperature equal to or higher than the melting point of an aluminum alloy constituting the outer panel member 30 and equal to or lower than the melting point of the solid-solution layer 324. By preventing the heating temperature in the laser welding step from becoming excessively high, a diffusion reaction time is shortened, a thickness of the intermetallic compound layer 327 can be sufficiently reduced, and joining strength of the laser welded portion 50 can be ensured. The laser welding step is preferably performed under a shielding gas in order to prevent oxidation of a surface of the outer member 21.

FIG. 13 is a schematic diagram illustrating a laser welded portion 50 formed in the manufacturing steps of the welded structure 10 according to the third embodiment. As illustrated in FIG. 13, the laser welded portion 50 (which is the first laser welded portion 53 or the second laser welded portion 58), in which an end portion of the outer panel member 30 is melted, is joined to the solid-solution layer 324. The laser welded portion 50 may be a part of the steel material 321, or may be composed of a material different from the steel material 321. It is preferable that only a thin intermetallic compound layer 327 be present at an interface between the laser welded portion 50 and the solid-solution layer 324. That is, it is preferable that the solid-solution layer 324 and the laser welded portion 50 be diffusion-joined by a diffusion reaction. If a surface layer 322 having a thickness similar to that at portions other than the laser welded portion 50 is present at the interface between the laser welded portion 50 and the solid-solution layer 324, diffusion bonding becomes difficult since diffusion reaction (atomic movement) is inhibited.

When Fe is included in the surface layer 322, Fe is included in the solid-solution layer 324, and therefore the intermetallic compound layer 327 is formed relatively thin only at an interface between the solid-solution layer 324 and the laser welded portion 50 in the outer panel member 30. Accordingly, formation of the intermetallic compound layer 327 at other portions, for example, inside the laser welded portion 50 other than at an interface with the solid-solution layer 324, can be prevented. Since the thickness of the intermetallic compound layer 327 at a toe portion 325 and a root portion 326 is sufficiently thin, joining strength of the laser welded portion 50 can be ensured. It is preferable that the thickness of the intermetallic compound layer 327 at the toe portion 325 and the root portion 326 be thinner than the thickness of the surface layer 322 at portions of the steel material 321 other than the laser welded portion 50. The thickness of the intermetallic compound layer 327 may be, for example, one-half or less, or may be one-third or less, of the thickness of the surface layer 322.

A melting point of the Fe–Al layer is not particularly limited, but is, for example, approximately 1280°C to 1480°C. The melting point of the Fe–Al layer is close to the melting point of iron, which is approximately 1560°C, as compared with the melting points of zinc-based platings. Therefore, when attempting to melt only the Fe–Al layer and join the Fe–Al layer to the outer panel member 30, it is necessary to adjust the melting temperature to a temperature between the melting point of the Fe–Al layer and the melting point of the base material, which makes it difficult to control the temperature. In the present embodiment, the Fe–Al layer is melted together with iron, which is the base material, to form the solid-solution layer 324, and the solid-solution layer 324 is joined, via the solid-solution layer 324, to the outer panel member 30 composed of an aluminum alloy having a melting point of approximately 660°C. Accordingly, temperature control during laser welding is facilitated.

Also in a case where the surface layer 322 of the outer member 21 is an oxide film layer or a galvannealed zinc plating (GA) layer, the surface layer 322 is melted together with the base steel material 321 to form the solid-solution layer 324, and the solid-solution layer 324 is joined to the outer panel member 30, similarly to a case where the surface layer 322 is an Fe–Al layer. Accordingly, temperature control during laser welding is facilitated. The melting point of iron oxide included in the oxide film layer as the surface layer 322 is approximately 1500°C. An upper limit of a melting point of a Zn–Fe alloy included in the galvannealed zinc plating (GA) layer as the surface layer 322 is approximately 782°C. The melting point of a material constituting the surface layer 322 is higher than the melting point of the outer panel member 30 composed of an aluminum alloy.

As described above, in the third embodiment, the plurality of members include at least an outer member 21, which is a steel plate composed of a steel material, and an outer panel member 30, which is an aluminum member composed of an aluminum alloy.

Accordingly, laser welding between a steel plate and an aluminum member, in which weldability at a welding start portion tends to become unstable, is dissimilar material joining that is difficult due to differences in melting point and thermal conductivity; however, this laser welding can be stably performed by the present technique in which both ends of the laser welded portion 50 do not become welding start portions.

The plurality of members include the skeletal member 20 composed of a steel plate, the skeletal member 20 being configured to form the closed cross section 100 by joining the outer member 21 and the inner member 22 at the inner-side flange portion 221 and the outer-side flange portion 211, and the outer panel member 30 composed of an aluminum member, the outer panel member 30 being welded to the outer-side flange portion 211 by laser welding.

Accordingly, it is no longer necessary to provide a width for intersecting laser welds as in conventional techniques, on the outer panel member 30, the inner-side flange portions 221, and the outer-side flange portions 211, thereby improving the degrees of freedom in layout and design of the outer panel member 30, the inner-side flange portions 221, and the outer-side flange portions 211.

Although preferred embodiments of the present invention have been described above, the present invention is not limited to the above embodiments, and modifications and improvements within a scope that can achieve the object of the present invention are included in the present invention.

### EXPLANATION OF REFERENCE NUMERALS

1: vehicle body component

10: welded structure

20: skeletal member

21: outer member

22: inner member

30: outer panel member

50: laser welded portion

51: first welding start portion

52: first welding end portion

53: first laser welded portion

56: second welding start portion

57: second welding end portion

58: second laser welded portion

61: first preceding welding start portion

62: first preceding welding end portion

66: second preceding welding start portion

67: second preceding welding end portion

What is claimed is:

1. A method of manufacturing a welded structure by laser-welding a plurality of members, the method comprising:
defining, with respect to an entire length of a single laser welded portion to be formed by the laser welding, a portion at which the laser welding is started from an intermediate region of the entire length as a first welding start portion;
performing first laser welding from the first welding start portion toward one end portion of the entire length; and
performing second laser welding from the first welding start portion toward the other end portion of the entire length, while including the first welding start portion.

2. The method of manufacturing the welded structure according to claim 1, wherein, within the entire length, a second welding length over which the second laser welding is performed is longer than a first welding length over which the first laser welding is performed.

3. The method of manufacturing the welded structure according to claim 1, wherein
the first laser welding includes: a first preceding laser step configured to heat surfaces of the plurality of members; and a first laser welding step configured to join the plurality of members after the first preceding laser step,
a first preceding welding start portion, which is a start of the first preceding laser step, is located closer to the other end portion than a first welding start portion, which is a start of the first laser welding step,
the second laser welding includes: a second preceding laser step configured to heat surfaces of the plurality of members; and a second laser welding step configured to join the plurality of members after the second preceding laser step, and
the second preceding laser step is performed from a second preceding welding start portion, which is a start of the second preceding laser step, toward the other end portion while overlapping the second preceding welding start portion with the first preceding welding start portion.

4. The method of manufacturing the welded structure according to claim 1, wherein the plurality of members include a steel plate composed of a steel material, and an aluminum member composed of an aluminum alloy.

5. The method of manufacturing the welded structure according to claim 4, wherein the plurality of members include:
a skeletal member composed of a steel plate and configured to form a closed cross section by joining an outer member and an inner member at a flange portion; and
an outer panel member composed of an aluminum member and welded to the flange portion by the laser welding.

6. A welded structure in which a plurality of members are joined by a laser welded portion formed by laser welding, the welded structure comprising:
a single laser welded portion having an entire length;
a first laser welded portion extending from a first welding start portion toward one end portion of the entire length, the first welding start portion being a portion at which the laser welding is started from an intermediate region of the entire length; and
a second laser welded portion extending from the first welding start portion toward the other end portion of the entire length, while including the first welding start portion.

7. The welded structure according to claim 6, wherein, in the entire length, a second welding length, which is a length of the second laser welded portion, is longer than a first welding length, which is a length of the first laser welded portion.

8. The welded structure according to claim 6, wherein the plurality of members include a steel plate composed of a steel material, and an aluminum member composed of an aluminum alloy.

9. The welded structure according to claim 8, wherein the plurality of members include:
a skeletal member composed of a steel plate and configured to form a closed cross section by joining an outer member and an inner member at a flange portion; and
an outer panel member composed of an aluminum member and welded to the flange portion by the laser welding.
